(19) United States
(12) Patent Application Publication
(10) Pub. No.: US 2026/0340357 A1
(43) Pub. Date: Oct. 29, 2026

(54) Automated Testing and Evaluation of Artificial Intelligence Agents

(71) Applicant: eBay Inc., San Jose, CA (US)

(72) Inventors: Lingjie Meng, Santa Clara, CA (US); Mudit Sahni, San Jose, CA (US); Sai Wang, Mountain View, CA (US); Xiaochen Wang, Mountain View, CA (US); Senthilnathan Subramanian, San Jose, CA (US); Praneeth Kumar Gone, Livermore, CA (US); Tingxian Cheng, Shanghai (CN); Xu Jun, Shanghai (CN)

(73) Assignee: eBay Inc., San Jose, CA (US)

(21) Appl. No.: 19/189,944

(22) Filed: Apr. 25, 2025

(51) Int. Cl. G06N 3/0475; G06N 3/045

(52) U.S. Cl. CPC G06N 3/0475; G06N 3/045

(57) ABSTRACT

Automated artificial intelligence (AI) agent evaluation is described. In one or more implementations, a first machine-learning model generates test prompts for a target AI agent based on testing guidance stored in a database, the testing guidance initially provided by a developer of the target AI agent. A second machine-learning model analyzes responses from the target AI agent to the test prompts to generate an analysis report of the target AI agent in view of the testing guidance. The second machine-learning model updates the guidance in the database for subsequent test prompts based on analysis of the responses. The second machine-learning model outputs the analysis report.

### BACKGROUND

Artificial intelligence (AI) agents are increasingly deployed in various domains to automate tasks and enhance user experiences. However, ensuring the reliability, security, and effectiveness of AI systems presents significant challenges. As AI agents become more sophisticated and are entrusted with more decision-making responsibilities, thorough testing and evaluation become more important. Conventional testing techniques often struggle to keep pace with the complexity, adaptability, and evolution of AI systems, potentially leaving vulnerabilities undetected.

### SUMMARY

An automated testing and evaluation framework leverages machine-learning models to continuously assess the security and performance of AI agents. In one or more implementations, the described system uses a machine-learning model of a question agent to generate test prompts for a target agent based on testing guidance stored in a guidance database. The guidance is initially provided by a developer or tester of the target agent. For example, the question agent can simulate various types of attacks to enhance the security of AI implementations based on the provided guidance. A second machine-learning model of an evaluation agent analyzes the responses from the target agent to the test prompts and generates an analysis report, which can include assessments of security vulnerabilities, behavioral alignment with defined objectives, and potential areas for further testing.

The evaluation agent updates the guidance in the guidance database based on analyzing the target agent's responses. The updated guidance informs subsequent test prompts, creating a continuous and dynamic evaluation system for target AI agents. The described approach enables more thorough and efficient testing than traditional manual techniques, potentially shortening the productization cycle for AI systems. In addition, the continuous nature of the testing, even post-launch, helps maintain the integrity of user interactions, supporting sustained customer trust.

This Summary introduces a selection of concepts in a simplified form that are further described below in the Detailed Description. As such, this Summary is not intended to identify essential features of the claimed subject matter, nor is it intended to be used to determine the scope of the claimed subject matter.

### BRIEF DESCRIPTION OF THE DRAWINGS

The detailed description is described with reference to the accompanying figures.

FIG. 1 illustrates an environment in an example implementation that is operable to employ techniques for automated testing and evaluation of AI agents.

FIG. 2 depicts an example testing system for pre-launch automated AI agent evaluations in accordance with techniques described herein.

FIG. 3 illustrates an example testing system for post-launch evaluation of artificial intelligence agents in accordance with techniques described herein.

FIG. 4 illustrates an example system for a question agent to generate automated AI agent evaluation test prompts.

FIG. 5 depicts a procedure in an example implementation of automated testing and evaluation of AI agents.

FIG. 6 illustrates an example of a system that may implement the various techniques described herein.

### DETAILED DESCRIPTION

### Overview

Deploying AI agents across domains like financial services, healthcare, and customer support has revolutionized automation and user experiences. However, ensuring the reliability, security, and effectiveness of these systems presents significant challenges. As AI agents become more sophisticated and are entrusted with decision-making responsibilities, thorough testing and evaluation become critical. Traditional testing techniques often struggle to keep pace with the complexity and adaptability of modern AI systems, potentially leaving vulnerabilities undetected and unaddressed. Furthermore, the dynamic nature of AI agents necessitates continuous monitoring and assessment beyond initial deployment.

Various approaches have been developed to address these challenges, including manual testing, static analysis, and limited automated testing frameworks. However, these traditional approaches cannot comprehensively evaluate AI agents throughout their lifecycle, from development to post-deployment. Manual testing is time-consuming and often does not cover many possible scenarios, while static analysis cannot fully capture the dynamic behavior of AI systems. Traditional automated testing frameworks typically lack the adaptability and continuous learning capabilities to keep pace with evolving AI agents.

An automated testing and evaluation framework that leverages machine-learning models is described to address these issues. The described system continuously evaluates and improves the security and performance of AI agents. In one or more implementations, the described techniques employ a first machine-learning model as a question agent to generate test prompts for a target AI agent based on testing guidance stored in a guidance database. A second machine-learning model of an evaluation agent analyzes the responses from the target AI agent to generate an analysis report. The evaluation agent updates the guidance database based on its analysis, creating a continuous and dynamic testing loop. In this way, the evaluation agent and question agent function in conjunction to identify potential vulnerabilities and performance issues and adapt and improve testing strategies based on ongoing analysis.

The described evaluation framework enables more thorough and efficient testing than traditional manual approaches, potentially shortening the AI agent productization cycle. The question agent's ability to simulate various types of attacks, including prompt injection and jailbreak attempts, enhances the security of AI agents. In addition, the continuous testing, even post-launch, helps maintain the integrity of user interactions, supporting sustained customer trust and potentially driving business metrics (e.g., Gross Merchandise Value (GMV) in e-commerce contexts).

The described evaluation framework also provides technical advantages regarding scalability and adaptability. By utilizing machine-learning models for test prompt generation and response evaluation, the described evaluation system can fine-tune the question agent using techniques like low-rank adaptation (LoRA) based on actual user queries to improve test coverage and relevance over time. This adaptive, self-improving testing framework ensures that the described system maintains effectiveness as AI technologies and potential vulnerabilities evolve, providing a more robust solution for AI agent evaluation.

In the following discussion, an exemplary environment is first described that may employ the techniques described herein. Examples of implementation details and procedures are then described which may be performed in the exemplary environment and other environments. Performance of the exemplary procedures is not limited to the exemplary environment, and the exemplary environment is not limited to the performance of the exemplary procedures.

### Example Testing Environment

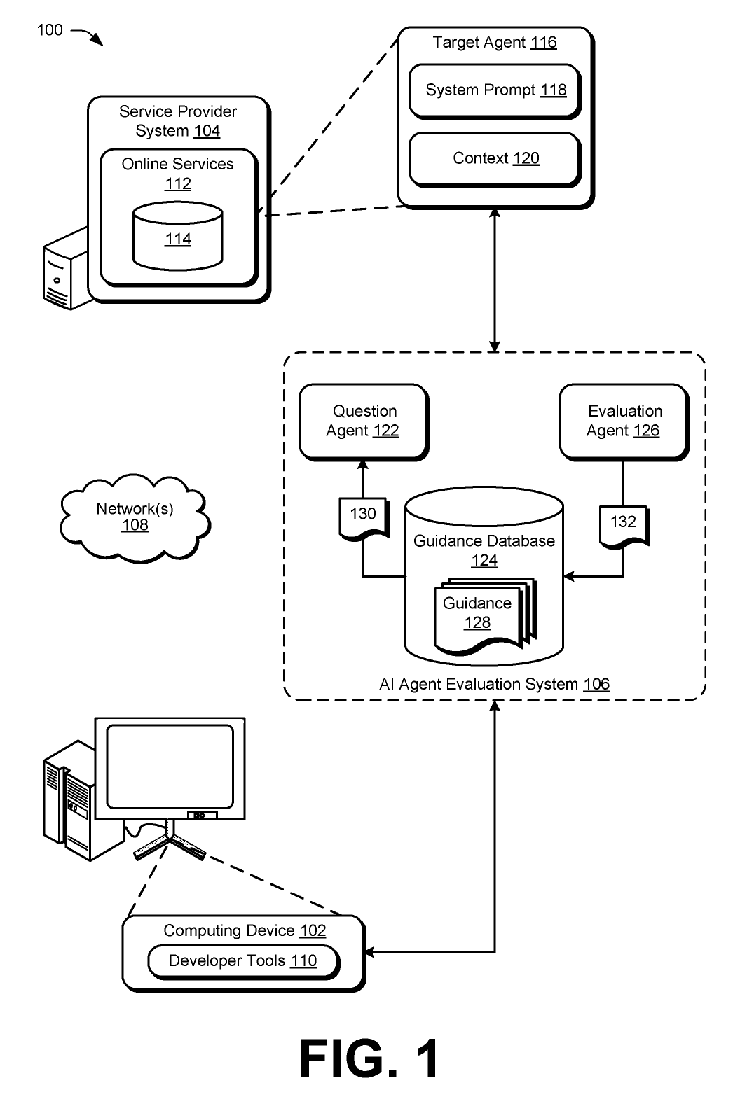

FIG. 1 illustrates an environment 100 in an example implementation that is operable to employ techniques for automated testing and evaluation of AI agents. The environment 100 includes a computing device 102, a service provider system 104, and an AI agent evaluation system 106. In one or more implementations, the computing device 102, the service provider system 104, and the AI agent evaluation system 106 are communicatively coupled, one to another, via one or more networks 108. One example of network 108 is the Internet. However, one or more of the computing device 102, the service provider system 104, or the AI agent evaluation system 106 may be communicatively coupled using different connections or networks in various implementations.

Although the AI agent evaluation system 106 is depicted in the environment 100 as being separate from the computing device 102 and the service provider system 104, in one or more implementations, an entirety or various portions of the AI agent evaluation system 106 are implemented at or by the computing device 102 and/or the service provider system 104. In at least one implementation, for example, at least a portion of the AI agent evaluation system 106 is implemented by developer tools 110 of the computing device 102 and/or using various resources of the computing device 102, such as hardware resources, an operating system, firmware, and so forth. Alternatively, or additionally, at least a portion of the AI agent evaluation system 106 is implemented by resources (e.g., server-based storage, processing, and so on) of the service provider system 104. Alternatively, at least a portion of the AI agent evaluation system 106 is implemented using a third-party service, such as a web services platform that provides one or more hardware and/or other computing resources to support the provision of services by web service providers.

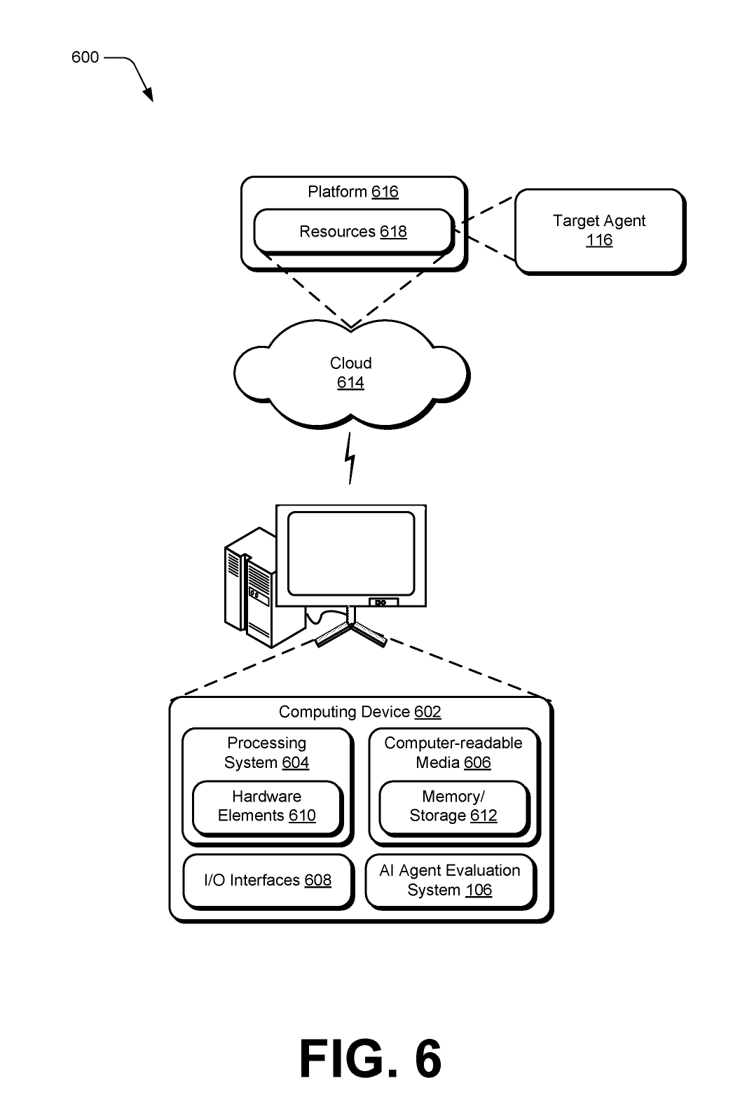

Computer systems that implement the environment 100 are configurable in various ways. A computer system, for instance, is configurable as a desktop computer, a laptop computer, a mobile device (e.g., assuming a handheld configuration such as a tablet or mobile phone), an AR/VR device (e.g., the smart glasses), a server, and so forth. Thus, computer systems range from full-resource devices with substantial memory and processor resources to low-resource devices with limited memory and/or processing resources. Additionally, although in instances in the following discussion, reference is made to the computing device 102 or the service provider system 104 in the singular, a computer system implemented by the computing device 102 and/or the service provider system 104 is also representative of a plurality of different devices, such as multiple servers of a server farm or data center utilized to perform operations “over the cloud” as further described in relation to FIG. 6.

The developer tools 110 enable interaction with the AI agent evaluation system 106. These developer tools 110 may provide interfaces for configuring test scenarios, viewing analysis reports, and implementing suggested improvements for a target AI system. In at least one implementation, the developer tools 110 supports communication of data across the network(s) 108, such as between the computing device 102 and the service provider system 104 and/or between the computing device 102 and the AI agent evaluation system 106. By supporting such data communication, the developer tools 110 provide a respective user (e.g., a developer) of the computing device 102 (and users of other computing devices) access to online services 112. For example, the computing device 102 receives data from the service provider system 104. Based on the received data, developer tools 110 causes various systems of the computing device 102 to output user interfaces of the online services 112, such as by displaying user interfaces via display devices or making accessible voice-based user interfaces.

Through user interaction with computer systems, an application receives user input via one or more user interfaces of the online services 112 (e.g., an online marketplace, collaborative work application, social media platform). Examples of such input include but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application is a browser, which is operable to navigate to a website of the online services 112, display pages of the website, and facilitate user interaction with web pages of the online services 112’s website. Another example of the application is a web-based computer application of the online services 112, such as a mobile or desktop application. The application may be configured in different ways, which enable users to interact with their computing devices and, by extension, perform actions on the online services 112, without departing from the spirit or scope of the techniques described herein.

In one or more implementations, users register with the service provider system 104 to obtain respective user accounts with the online services 112. Such registration may include, for instance, providing an email address and establishing a username and password combination. After registering with the service provider system 104, computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online services 112 may be a guest account that does not require a user to sign in or otherwise authenticate to an already established account before interacting with the online services 112.

In the illustrated environment 100, the online services 112 include a storage device 114, which is depicted as maintaining real-time data. The storage device 114 may represent one or more databases and/or other types of storage capable of storing data related to the online services 112, users thereof, or the target agent 116. Examples of the storage device 114 include, but are not limited to, mass storage and virtual storage. In one or more implementations, for example, the storage device 114 may be virtualized across a plurality of data centers and/or cloud-based storage devices. The service provider system 104 may implement the online services 112 by using servers that execute stored instructions to deploy various services of the service provider system 104, such that those services perform numerous computations that effectively provide the functionality described above and below. It is to be appreciated that the online services 112 may include more, fewer, or different components without departing from the spirit or scope described herein.

In one or more implementations, the online services 112 are accessible by decentralized computing devices that correspond to “clients” of the online services 112, e.g., users that have accounts with the online services 112 and/or that access the online services 112 as a “guest” that is not signed to such an account or tracked as a user with an account.

The target agent 116 functions as an AI-powered assistant designed to support users of the online services 112. The target agent 116 includes a system prompt 118 and context 120 that inform responses. The target agent 116 processes user inputs using a predefined system prompt 118 and context 120, which condition the responses of the target agent 116. The target agent 116 processes these system prompts 118 with associated context 120, which may include user history, preferences, or relevant data from the online services 112. By leveraging this context 120, the target agent 116 generates and provides tailored responses to users, enhancing their experience with the online services 112.

The AI agent evaluation system 106 is an automated testing framework to assess and improve the security, performance, and reliability of the target agent 116. The AI agent evaluation system 106 generates test prompts through a question agent, analyzes responses, and continuously updates testing strategies based on the results. For example, the AI agent evaluation system 106 includes a question agent 122, a guidance database 124, and an evaluation agent 126. The question agent 122 generates test prompts for the target agent 116 based on guidance 128 stored in the guidance database 124. The evaluation agent 126 analyzes responses from the target agent 116 and provides updated guidance 132 to the guidance database 124.

The question agent 122 generates test prompts for the target agent 116. In at least one implementation, the question agent 122 utilizes a large language model (LLM) to leverage LLM capabilities for generating diverse and contextually relevant test prompts. These capabilities include natural language understanding, context awareness, and creating human-like text across various domains and styles. The question agent 122 receives guidance 130 from the guidance database 124 to inform the generation of test prompts. This guidance includes specific testing objectives, known vulnerabilities to probe, or particular interaction patterns to simulate. The LLM implementation allows question agent 122 to dynamically adapt its prompt generation based on the provided guidance, potentially uncovering edge cases or vulnerabilities that more rigid testing approaches might miss. Additionally, the LLM's ability to understand and generate natural language enables the creation of test prompts that closely mimic real-world user interactions, enhancing the overall effectiveness of the testing process.

The evaluation agent 126 examines responses from the target agent 116 to the test prompts generated by the question agent 122. The evaluation agent 126 is typically implemented as an LLM, similar to the question agent 122. In its analysis, the evaluation agent 126 assesses multiple aspects of the target agent's responses, including their quality, relevance, and security implications. This comprehensive evaluation considers response accuracy, coherence, adherence to specified guidelines, and potential vulnerabilities. The evaluation agent 126 utilizes advanced natural language processing techniques to perform deep semantic analysis, identifying nuances in the responses that may indicate strengths or weaknesses in the target agent's performance. Based on this thorough examination, the evaluation agent 126 generates updated guidance 132 for the guidance database 124. This updated guidance 132 incorporates insights from the analysis, refining the testing strategies and focus areas for subsequent iterations. The continuous feedback loop created by this process allows for dynamic adaptation of the testing framework, ensuring that it evolves alongside the target agent's capabilities and potential vulnerabilities.

The environment 100 supports both pre-launch and post-launch testing stages for AI agents. In the pre-launch stage, the AI agent evaluation system 106 tests the target agent 116 before user deployment. The pre-launch investigation includes generating various test prompts to assess the performance, security, and alignment with the intended behaviors of the target agent 116. In the post-launch stage, the AI agent evaluation system 106 evaluates the target agent 116 based on actual user and simulated interactions. For example, the AI agent evaluation system 106 monitors and analyzes conversations between users and the target agent 116, using this data to refine the testing process further and identify improvement areas.

As described above, the guidance database 124 provides guidance 128 to the question agent 122 in generating test prompts. The guidance 128 may include diverse testing parameters, such as specific security vulnerabilities to probe, interaction patterns to simulate, or performance benchmarks to evaluate. For example, the guidance 128 might specify testing scenarios that involve attempting prompt injection attacks or simulating conversations with users with limited technical knowledge. The question agent 122 interprets this guidance to dynamically generate test prompts that align with the current testing objectives, adapting its approach based on the specific aspects of the target agent 116 being evaluated. By leveraging the guidance 128, the question agent 122 can create a wide range of test scenarios that comprehensively assess the target agent's capabilities and potential weaknesses.

Initially, the guidance database 124 is populated with guidance 128 provided by developers. As the evaluation process progresses, the evaluation agent 126 updates the guidance database 124 with new insights and testing strategies, creating a dynamic and evolving testing framework. In some implementations, the guidance database 124 stores historical performance data, question templates, and other relevant information to support the evaluation process.

The question agent 122 and evaluation agent 126 function cooperatively to create a continuous feedback loop. The question agent 122 generates test prompts based on the current guidance 130 from the guidance database 124. The evaluation agent 126 analyzes the responses from the target agent 116 and provides updated guidance 132 back to the guidance database 124. As the system encounters new types of reactions or identifies potential vulnerabilities, the guidance database 124 may be updated to incorporate these insights. This process allows the testing framework to adapt and improve over time, potentially uncovering new vulnerabilities or areas for enhancement in the target agent 116.

In one or more implementations, the AI agent evaluation system 106 includes a feedback agent that interacts with the current guidance in the guidance database 124, additional guidance provided by developers through the developer tools 110, output from the evaluation agent 126, and contextual data related to the target agent 116. The feedback agent processes this information to provide refined input to the guidance database 124, further enhancing the adaptive nature of the evaluation system.

Having considered an example of an environment, consider now a discussion of some example details of the techniques for rules based override of machine learning output in accordance with one or more implementations.

### AI Agent Evaluation System

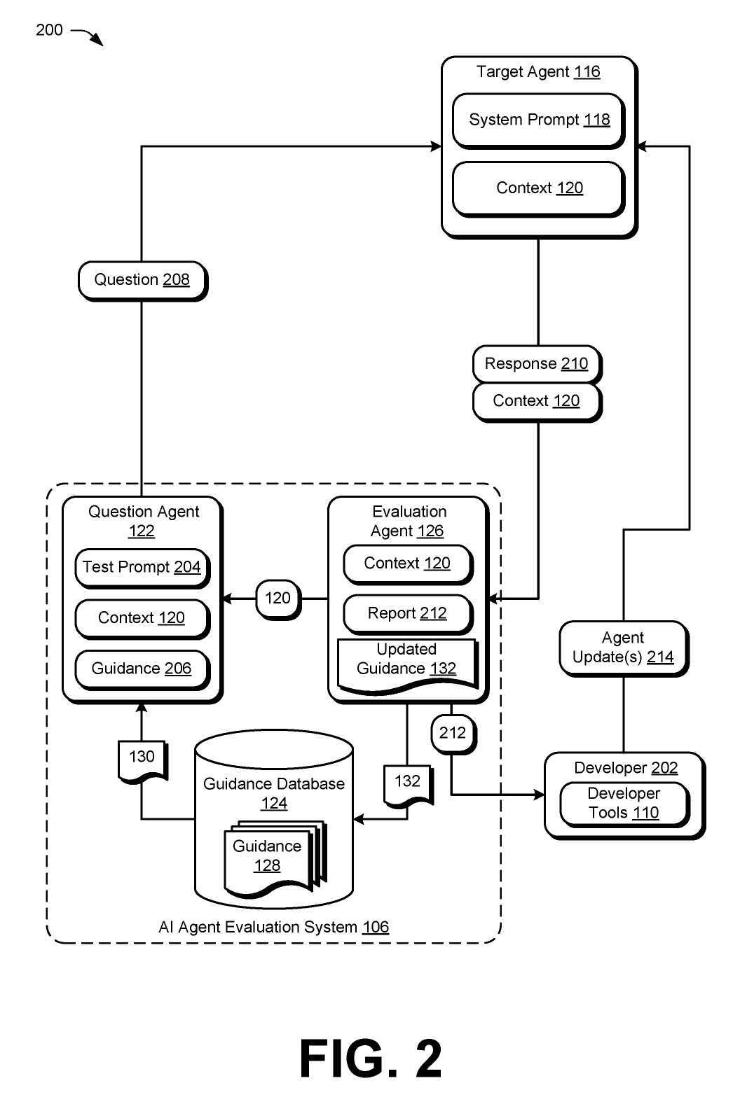

FIG. 2 illustrates an example testing system 200 for pre-launch automated AI agent evaluations in accordance with techniques described herein. The testing system 200 provides a framework for evaluating and refining a target agent 116 before deployment. In this way, developers can assess the performance, security, and reliability of target agents 116 by utilizing machine-learning models to generate test prompts, analyze responses, and provide actionable insights for improving AI agent functionality.

A developer 202 initiates the testing process by interacting with the testing system 200 through developer tools 110. The developer 202 provides initial testing guidance 128 to the guidance database 124 and configuration parameters to tailor the evaluation process for the target agent 116 under review. The input from the developer 202 establishes the testing scenarios and objectives, ensuring that the evaluation aligns with the intended use case and requirements of the target agent 116.

The question agent 122 uses a machine-learning model to generate test prompts 204 for the target agent 116 based on the guidance 128 stored in the guidance database 124. For example, the question agent 122 leverages a Large Language Model (LLM) to generate diverse and contextually relevant test prompts 204. The LLM utilizes its natural language understanding and generation capabilities to generate the test prompts 204. The question agent 122 provides the LLM with inputs including the current guidance 130 from the guidance database 124, the context 120 of the target agent 116, and any specific testing objectives or known vulnerabilities to probe stored in guidance 206. The question agent 122 can use templates or guidelines for creating diverse and relevant test prompts 204 based on guidance 206 stored in or maintained by the question agent 122. As described above, guidance 206 may include specific testing objectives, known vulnerabilities to probe, or particular interaction patterns to simulate. These inputs shape the LLM's output to align with the current testing goals and target agent characteristics.

The prompt generation process includes several steps. First, the question agent 122 formulates an input query for the LLM based on the provided guidance and context. The LLM then processes this query to generate candidate prompts. In one implementation, the question agent 122 applies additional filtering or refinement techniques to ensure the generated prompts meet specific criteria, such as adhering to particular interaction patterns or simulating specific user behaviors. The LLM's ability to understand and generate human-like text across various domains and styles allows question agent 122 to create test prompts 204 that closely mimic real-world user interactions, potentially uncovering edge cases or vulnerabilities that more rigid testing approaches might miss. The test prompts 204 are provided to the target agent 116 as one or more questions 208.

The target agent 116 receives the questions 208 generated by the question agent 122 and processes them using the system prompt 118 and context 120. The target agent 116 then produces responses 210 based on its current capabilities and understanding of the input.

The evaluation agent 126 uses a machine-learning model to analyze responses 210 from the target agent 116 to the questions 208 posed by the question agent 122. This analysis involves assessing the quality, relevance, and security implications of the responses 210 by the target agent 116. The evaluation agent 126 generates a report 212 analyzing the responses 210 in view of the testing guidance 128. This report 212 may include metrics on response accuracy, adherence to specified guidelines, and potential vulnerabilities identified during the testing process.

The flow of information within the testing system 200 follows a cyclical pattern. Initially, the question agent 122 receives guidance from the guidance database 124 and generates the question 208 for the target agent 116. The target agent 116 processes the question 208 using the system prompt 118 and context 120 to produce the response 210. This response 210 is passed to the evaluation agent 126 for analysis.

From the evaluation agent 126, the analyzed information flows in two directions. First, the evaluation agent 126 generates a report 212 provided to the developer 202 through the developer tools 110. This report 212 provides insights and recommendations for improving the target agent 116. Second, the evaluation agent 126 produces updated guidance 132 fed back into the guidance database 124. This updated guidance 132 informs subsequent test prompt generation by the question agent 122, creating a feedback loop that continuously refines the testing process. The updated guidance 132 incorporates insights from the evaluation process, refining the testing strategies and focus areas of the guidance 128 in the guidance database 124 for future iterations.

The developer 202 may review the report 212 and implement agent updates 214 to enhance the target agent 116 based on the evaluation results. These agent updates 214 may involve adjusting the system prompt 118, refining the context 120 processing, or modifying underlying algorithms of the target agent 116. After implementing the agent updates 214, the developer 202 may initiate additional testing cycles to verify improvements and identify any new areas for refinement or supplement the guidance 128 in the guidance database 124.

The testing system 200 also operates iteratively, with each cycle potentially uncovering new insights or areas for improvement. As the question agent 122 generates new test prompts 204 based on updated guidance, and the evaluation agent 126 analyzes subsequent responses, the testing system 200 continuously adapts the testing strategies. This adaptive approach allows the testing system 200 to evolve alongside the target agent 116, ensuring comprehensive evaluation as the AI system develops. The continuous generation of diverse test prompts 204 exposes the target agent 116 to a wide range of scenarios, helping to identify and address potential weaknesses. In addition, the evaluation process provides specific insights into areas where the target agent 116 may be underperforming, allowing for targeted improvements. Finally, the dynamic updating of the guidance database 124 ensures that the testing process remains relevant and challenging as the target agent 116 improves over time.

In one implementation, the feedback loop may incorporate machine-learning techniques that analyze patterns in the target agent's responses over multiple iterations. The machine-learning techniques help identify trends in performance improvements or persistent issues, further informing the refinement of the testing process (e.g., via the updated guidance 132) and the target agent 116 (via agent updates 214).

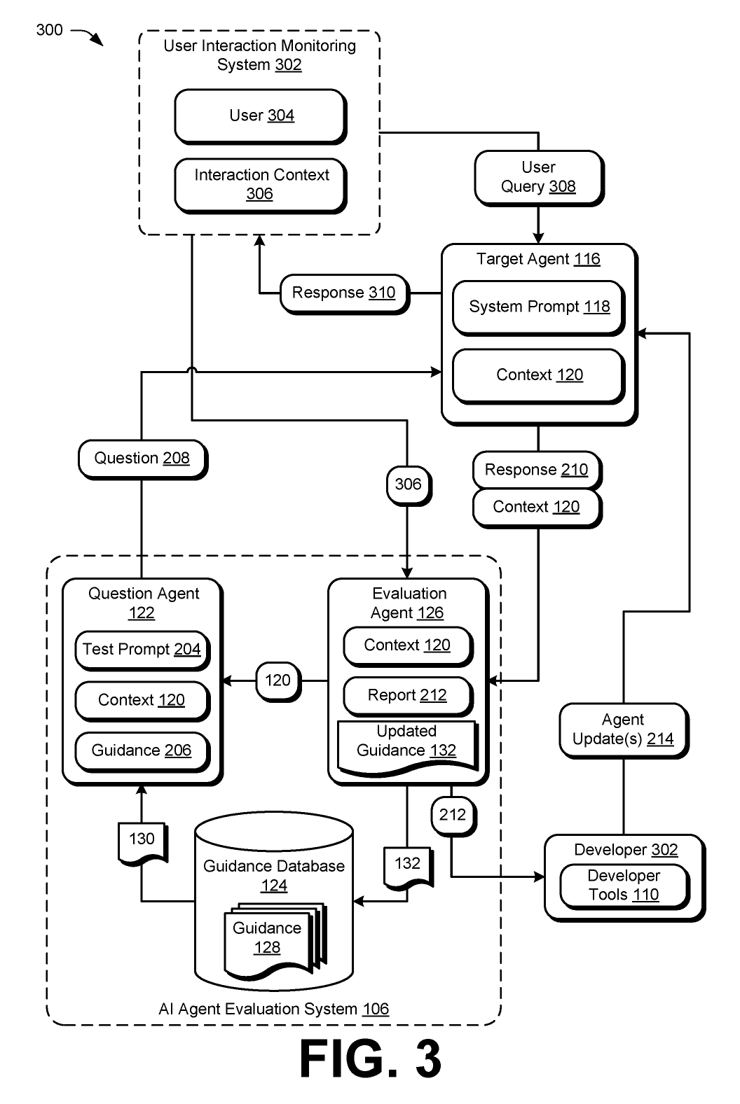

FIG. 3 illustrates an example testing system 300 for post-launch evaluation of artificial intelligence agents in accordance with techniques described herein. The testing system 300 provides a framework for evaluating and refining a target agent 116 after deployment. The testing system 300 builds upon the testing system 200 by incorporating a user interaction monitoring system 302.

The user interaction monitoring system 302 enables continuous assessment of the performance of the target agent 116 in real-world usage scenarios. By capturing actual interactions between users 304 and the target agent 116, the user interaction monitoring system 302 provides valuable data for ongoing AI system refinement and improvement. The user interaction monitoring system 302 logs and analyzes conversations between users 304 and the target agent 116 during live operations.

A user 304 interacts with the target agent 116 through the online services 112 or other interfaces provided by the service provider system 104. The user interaction monitoring system 302 observes these interactions, capturing the user query 308 sent to the target agent 116 and the corresponding response 310 generated by the target agent 116. In addition to the direct exchange, the user interaction monitoring system 302 may also record interaction context 306.

The interaction context 306 includes information such as the user's session history, time of interaction, device type, or relevant metadata associated with the user's account or the user queries 308. In some implementations, the interaction context 306 also includes environmental factors, such as current events or trending topics, that could influence the nature of user queries and the target agent's responses. The comprehensive logging allows for a more nuanced understanding of how the target agent 116 performs across diverse real-world scenarios. The user interaction monitoring system 302 continues to track the user's reaction to the response 310, updating the interaction context 306 accordingly, including monitoring whether the user 304 asks follow-up questions, indicates satisfaction with the response, or terminates the interaction.

The data collected by the user interaction monitoring system 302 assists the testing system 300 in several aspects. Firstly, the logged interactions provide a rich dataset for the evaluation agent 126 to analyze, offering insights into the performance of the target agent 116 across a wide range of real-world scenarios. This analysis helps the evaluation agent 126 to identify patterns, strengths, and potential areas for improvement that may not have been identified during pre-launch testing.

Secondly, the captured data is used to refine and update the guidance 128 stored in the guidance database 124. By incorporating actual user interactions, the guidance database 124 adapts to reflect actual usage patterns and challenges faced by the target agent 116 in live environments. The updated guidance 132 then informs the question agent 122 in generating more relevant and realistic test prompts for ongoing evaluation and improvement of the target agent 116. The updated guidance 132 may reflect new patterns in user queries, identify areas where the target agent 116 consistently performs well or struggles, or highlight emerging topics that require additional training.

The question agent 122 uses the current guidance 130 to generate more relevant and realistic test prompts 204 for ongoing evaluation of the target agent 116. In some implementations, the question agent 122 is fine-tuned using low-rank adaptation (LoRA) techniques based on the user queries 308 captured by the user interaction monitoring system 302. The fine-tuning improves ability of the question agent 122 to generate test prompts 204 that mimic actual user interactions, thereby enhancing the overall test coverage. By leveraging user interactions and continuously updating the guidance database 124, the testing system 300 ensures that the evaluation process remains relevant and effective as user behavior and expectations evolve.

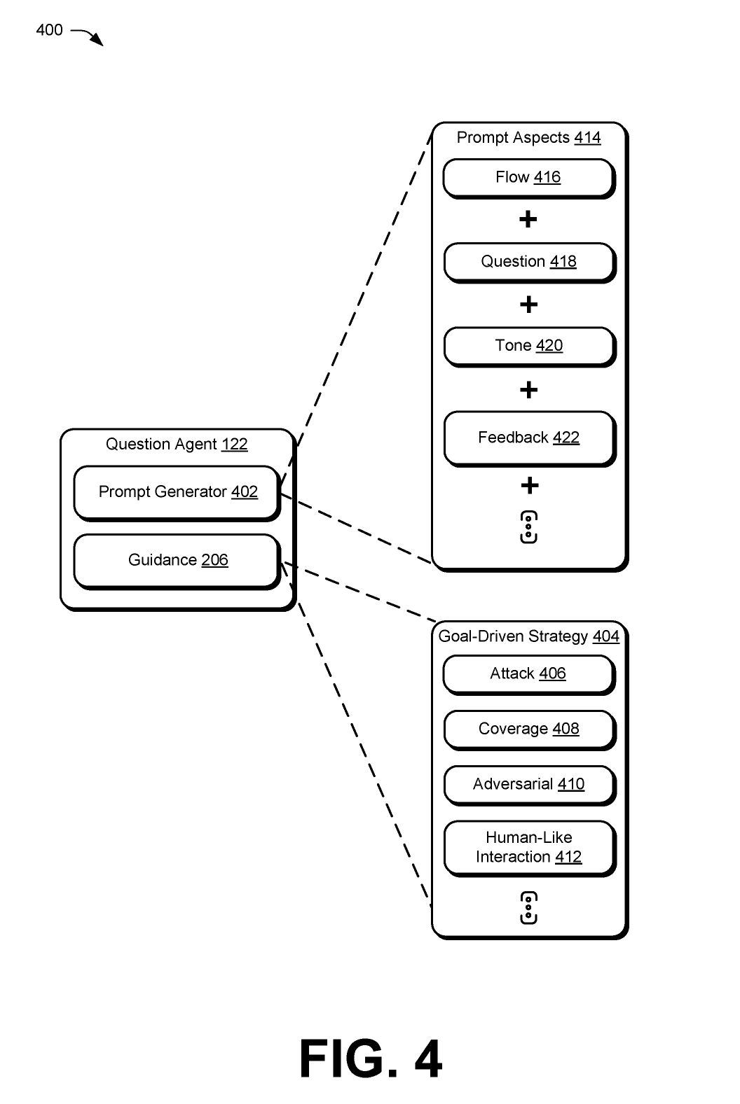

FIG. 4 illustrates an example system 400 for the question agent 122 of FIG. 1 to generate automated AI agent evaluation prompts. The question agent 122 includes the guidance 206 obtained from the guidance database 124 and a prompt generator 402.

In one implementation, the guidance 206 includes goal-driven strategies 404 that define the overall objectives and approaches for AI agent evaluation. The goal-driven strategies 404 can include one or more of the following strategies: attack 406, coverage 408, adversarial 410, and human-like interaction 412 strategies.

The attack 406 strategy focuses on generating test prompts that probe potential security vulnerabilities of the target agent 116. In some implementations, test prompts under the attack 406 strategy include adversarial inputs such as prompt injection attacks, jailbreak attempts, or unauthorized access scenarios. By incorporating these prompts, the system 400 assesses the resilience of the target agent 116 against various security threats.

The coverage 408 strategy provides comprehensive testing across a wide range of scenarios. This strategy guides the prompt generator 402 to create test prompts that explore different topics, interaction styles, or complexity levels, helping to evaluate the performance of the target agent 116 across diverse situations.

The adversarial 410 strategy generates prompts designed to challenge the robustness and decision-making capabilities of the target agent 116. Such prompts may include edge cases, ambiguous queries, or scenarios that require nuanced understanding.

The human-like interaction 412 strategy induces prompts that mimic natural user behavior. This approach helps evaluate how well the target agent 116 handles realistic conversations and user queries. In one or more implementations, the prompt generator 402 utilizes one or more goal-driven strategies 404 for a series of test prompts.

The prompt generator 402 uses an LLM (or other machine-learning models) to create diverse and contextually relevant test prompts for evaluating the target agent 116. By leveraging the LLM's natural language understanding and generation capabilities, the prompt generator 402 can analyze input parameters, contextual information (e.g., the context 120), and guidance from the goal-driven strategies 404 to formulate a wide range of test scenarios. The LLM-based approach allows the prompt generator 402 to create linguistically complex and semantically rich prompts that closely mimic real-world user interactions. In some implementations, the prompt generator 402 is fine-tuned or adapted to produce prompts tailored to specific domains, testing requirements, or emerging patterns identified through the evaluation process. Integrating LLM technology with the prompt generator 402 enables the system to continuously evolve its testing strategies, potentially uncovering edge cases or vulnerabilities that more rigid testing approaches might miss.

In light of the goal-driven strategies 404 provided in guidance 206, the prompt generator 402 uses prompt aspects 414 to create the test prompts. The goal-driven strategies 404 guide the overall approach to test prompt creation, while the prompt aspects 414 influence the specific characteristics of the generated prompts. The prompt aspects 414 include several elements that affect the characteristics of the generated test prompts: flow 416, question 418, tone 420, and feedback 422. These prompt aspects 414 allow the prompt generator 402 to create test prompts with varying conversation structures, content types, communication styles, and responsiveness to previous interactions.

The flow 416 aspect guides the structure and progression of the generated prompts. In some implementations, this aspect guides the prompt generator 402 to create multi-turn conversations or scenarios that induce the target agent 116 to maintain context over multiple exchanges. The question 418 aspect focuses on the content and format of the queries within the test prompts, which includes generating different types of questions, such as open-ended inquiries, specific requests for information, or hypothetical scenarios. The tone 420 aspect allows the prompt generator 402 to vary the communication style of the test prompts. In this way, the prompt generator 402 can generate test prompts with different emotional tones, levels of formality, or cultural nuances to assess the ability of the target agent 116 to adapt its responses appropriately. The feedback 422 aspect incorporates information from previous interactions or responses into subsequent prompts, allowing the prompt generator 402 to create dynamic testing scenarios that evolve based on the performance of the target agent 116. The prompt aspects 414 can include additional or fewer aspects in other implementations.

By combining inputs from both the goal-driven strategy 404 and prompt aspects 414, the prompt generator 402 creates a wide range of test prompts. These prompts may be designed to evaluate different aspects of the target agent's performance, including its ability to handle potential security threats, maintain coherent conversations, and provide appropriate responses across various scenarios. The selected goal-driven strategy 404 informs the choice and application of relevant prompt aspects 414. Consider a human-like interaction 412 strategy is selected, the prompt generator 402 may focus on the question 418 and tone 420 aspects to create prompts that probe potential vulnerabilities while maintaining a realistic interaction style. As the prompt generator 402 creates test prompts, the goal-driven strategy 404 ensures that each prompt aligns with the current evaluation objectives. Simultaneously, the prompt aspects 414 are incorporated to shape the specific characteristics of each prompt, such as its structure, content, and style.

The combination of the goal driven strategy 404 and prompt aspects 414 allows the prompt generator 402 to generate a diverse range of test prompts that comprehensively evaluate the target agent 116. For instance, a single testing session may include prompts that assess security flaws, explore potential areas for improvement, and evaluate its behavioral alignment with defined objectives.

As described with respect to FIGS. 1-3, the evaluation agent 126 analyzes the responses from the target agent 116 to the generated test prompts. In some scenarios, this analysis includes an assessment of the security flaws of target agent 116 and the identification of any vulnerabilities exposed during the testing process. The evaluation agent 126 can generate a list of potential areas to explore in subsequent test prompts, allowing the system 400 to adapt its testing strategy via the goal-driven strategies emphasized in the guidance 206.

### Example Procedures

This section describes examples of procedures for automated AI agent evaluation. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

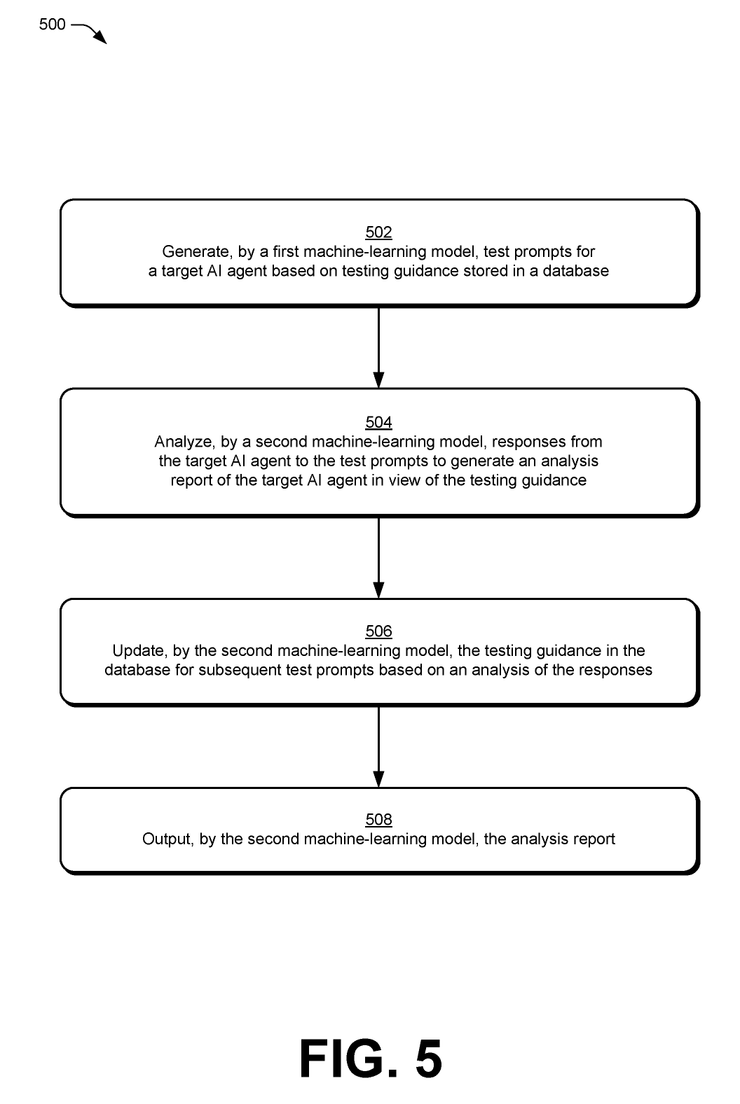

FIG. 5 depicts a procedure 500 in an example implementation of automated testing and evaluation of AI agents.

A first machine-learning model generates test prompts for a target AI agent based on testing guidance stored in a database (block 502). For example, the question agent 122 uses an LLM to generate test prompts. The question agent 122 can leverage the capabilities of the LLM within the prompt generator 402 to create diverse and contextually relevant test prompts.

The initial testing guidance provided by the developer of the target AI agent may be input through the developer tools 110. The developer tools 110 include a graphical user interface that allows developers to specify guidance in various formats, such as natural language instructions, structured data objects, or code snippets relevant to the target agent 116. In one implementation, the guidance input process includes authenticating the developer to the AI agent evaluation system 106, selecting the specific target agent 116 for which guidance is provided, and inputting the guidance using available input methods.

Once submitted, the AI agent evaluation system 106 processes the guidance by parsing it according to its format, validating it for consistency and completeness, and storing the guidance in the guidance database 124 linked to the specific target agent 116. The stored guidance 128 is then used by the question agent 122 to generate test prompts and by the evaluation agent 126 to assess responses. In some implementations, the developer tools 110 provide functionality for developers to version and iterate on their guidance, allowing for refinement of the testing process as the target agent 116 evolves.

In some implementations, the first machine-learning model generates a tree-structured conversation flow to guide the generation of test prompts. This tree structure allows for the creation of multi-turn conversations or branching dialogue paths, enabling more comprehensive testing of the ability of the target agent 116 to maintain context and handle complex interactions. The tree-structured conversation flow provides a framework for creating dynamic and contextually rich test prompts. By leveraging the prompt aspects 414 (e.g., flow 416, question 418, tone 420, and feedback 422), the prompt generator 402 constructs intricate dialogue paths that simulate realistic user interactions. This tree-structured approach allows the question agent 122 to explore various conversation branches, enabling the evaluation of the ability to maintain context across multiple turns and adapt to changing conversational directions.

The tree structure also facilitates the creation of test scenarios that progressively increase in complexity, starting with simple queries and evolving into more nuanced exchanges. For example, a conversation path might begin with a basic question about a product and then branch into different scenarios based on the target agent's initial response. One branch could explore the target agent's ability to handle follow-up questions, while another could test its capacity to manage topic shifts or emotional changes in the simulated user's tone. Such prompt generation is particularly effective for assessing the contextual understanding and long-term memory capabilities of the target agent 116. By creating interconnected dialogue paths, the AI agent evaluation system 106 evaluates how well the target agent 116 maintains consistency across multiple interactions, recalls previously mentioned information, and applies it appropriately in subsequent responses.

In addition, the tree-structured approach enables the question agent 122 to test complex decision-making scenarios. The prompt generator 402 can design conversation flows that present the target agent 116 with ambiguous situations or ethical dilemmas, allowing for a comprehensive assessment of its reasoning capabilities and adherence to predefined guidelines or ethical standards.

Using a tree structure also enhances the efficiency of the evaluation process. The question agent 122 can systematically explore various interaction patterns while avoiding redundant testing paths to conserve system resources and time. This structured approach also ensures comprehensive coverage of potential user interactions, helping to identify edge cases or unexpected behaviors that might not be apparent in linear conversation flows.

A second machine-learning model analyzes responses from the target AI agent to the test prompts to generate an analysis report of the target AI agent in view of the testing guidance (block 504). For example, the second machine-learning model is implemented as part of the evaluation agent 126. In some scenarios, the analysis includes an assessment of security flaws of the target agent 116, an evaluation of behavioral alignment of the target agent 116 to defined objectives, and a list of potential areas to explore in subsequent test prompts.

The second machine-learning model updates the testing guidance in the database for subsequent test prompts based on an analysis of the responses (block 506). For example, the evaluation agent 126 creates a feedback loop that allows the AI agent evaluation system 106 to adapt and improve over time. The updated guidance 132 may incorporate new insights, identified vulnerabilities, or areas where the target agent 116 consistently performs well or struggles.

The second machine-learning model then outputs the analysis report (block 508). For example, the analysis report includes metrics on response accuracy, adherence to specified guidelines, and potential vulnerabilities identified during testing. In some implementations, the analysis report also includes suggested improvements for the target agent 116 and evaluation results based on a scoring template with metrics for assessing response quality, including relevance, completeness, and ethical considerations.

In at least one implementation, the evaluation agent 126 uses advanced natural language processing techniques to perform deep semantic analysis of the responses from the target agent 116. For example, the second machine-learning model parses the syntactic structure of the responses, extracts key entities and concepts, and analyzes their relationships within the conversation context. The evaluation agent 126 utilizes a pre-trained language model to generate embeddings for the responses, allowing for a nuanced understanding of the semantic content. The embeddings can be compared against expected response patterns or benchmarks stored in the guidance database 124 to assess the quality and relevance of the target agent's outputs.

To identify strengths and weaknesses across multiple domains, the evaluation agent 126 can use a multi-faceted evaluation framework, which includes domain-specific knowledge bases, taxonomies, and evaluation criteria stored in the guidance database 124. For example, the evaluation agent 126 maps the analyzed responses to the domain-specific resources, assessing the performance of the target agent 116 in areas such as factual accuracy, reasoning coherence, and domain-specific knowledge application. The second machine-learning model also uses a set of heuristics or machine-learning classifiers trained on domain-specific datasets to categorize responses and identify areas where the target agent 116 excels or requires improvement.

The analysis by the evaluation agent 126 accounts for different interaction styles by incorporating contextual information and metadata associated with each test prompt. The evaluation agent 126 considers factors such as the conversation history, the specific prompt aspects 414 used in generating the test prompts, and the goal-driven strategy 404 employed. By analyzing these contextual elements with the semantic content of the responses, the evaluation agent 126 assesses how well the target agent 116 adapts its communication style and content to different scenarios. This assessment can include evaluating metrics such as tone consistency, appropriateness of formality level, and ability to maintain context across varying interaction patterns defined by the flow 416 aspect of the prompt generator 402.

Procedure 500 can include additional steps for post-launch evaluation. For example, the user interaction monitoring system logs interactions between human users and the target agent 116. The interactions are analyzed by the evaluation agent 126 to further update the guidance in the guidance database 124, ensuring that the evaluation process remains relevant to real-world usage scenarios. In one implementation, the first machine-learning model of the question agent 122 is fine-tuned using low-rank adaptation LoRA techniques based on actual user queries to improve test coverage. The fine-tuning enhances the ability of the prompt generator 402 to generate test prompts that closely mimic actual user interactions, thereby improving the overall effectiveness of the evaluation process.

In one implementation, the first machine-learning model is fine-tuned using LoRA techniques by introducing trainable rank decomposition matrices to the architecture of the first machine-learning model. These matrices are applied to specific model layers, such as the attention layers while keeping other layers fixed. For example, the LoRA matrices are initialized with small random values and then optimized during the fine-tuning process, allowing for efficient adaptation of the first machine-learning model to the specific domain of user queries without modifying the entire model architecture.

The fine-tuning process includes collecting a dataset of user interactions with the target agent 116. This dataset can be preprocessed to extract relevant features and patterns representative of the types of queries users typically submit. The question agent 122 uses the preprocessed data to update its parameters through gradient descent, focusing on optimizing the LoRA matrices. In some implementations, the fine-tuning process is performed incrementally, with the model being updated periodically as new user queries become available, allowing for continuous adaptation to evolving user behavior.

In at least one implementation, applying LoRA techniques includes selecting key layers of the first machine-learning model for adaptation, such as the query and key projection matrices in the attention mechanism. The rank of the decomposition matrices can be chosen based on a desired trade-off between model adaptability and computational efficiency. For example, the AI agent evaluation system 106 uses a validation set of user queries to monitor the performance of the fine-tuned model and adjust the LoRA hyperparameters accordingly.

Procedure 500 operates iteratively, with each cycle potentially uncovering new insights or areas for improvement. As the first machine-learning model of the question agent 122 generates new test prompts based on updated guidance, and the second machine-learning model of the evaluation agent 126 analyzes subsequent responses, procedure 500 continuously adapts the testing strategies. The adaptive approach allows the AI agent evaluation system 106 to evolve alongside the target agent 116, ensuring comprehensive assessment as the AI system develops.

Having described examples of procedures in accordance with one or more implementations, consider now an example of a system and device that can be utilized to implement the various techniques described herein.

### Example System and Device

FIG. 6 illustrates an example of a system 600 that includes a computing device 602 representative of one or more computing systems and/or devices that may implement the techniques described herein. This is illustrated by including the AI agent evaluation system 106 and the target agent 116. The computing device 602 may be, for example, a service provider server, a device associated with a client (e.g., a client device), an on-chip system, and/or any other suitable computing device or computing system.

The example computing device 602, as illustrated, includes a processing system 604, one or more computer-readable media 606, and one or more I/O interfaces 608 that are communicatively coupled, one to another. Although not shown, the computing device 602 may further include a system bus or other data and command transfer system that couples the various components from one to another. A system bus can include any one or combination of different bus structures, such as a memory bus or memory controller, a peripheral bus, a universal serial bus, and/or a processor or local bus that utilizes various bus architectures. Various other examples are also contemplated, such as control and data lines.

The processing system 604 represents the functionality to perform one or more operations using hardware. Accordingly, the processing system 604 is illustrated as including hardware elements 610 that may be configured as processors, functional blocks, and so forth. This may include implementation in hardware as an application-specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 606 is illustrated as including memory/storage 612. The memory/storage 612 represents memory/storage capacity associated with one or more computer-readable media. The memory/storage 612 may include volatile media (such as random-access memory (RAM)) and/or nonvolatile media (such as read-only memory (ROM), Flash memory, optical disks, magnetic disks, and so forth). The memory/storage 612 may include fixed media (e.g., RAM, ROM, a fixed hard drive, and so on) and removable media (e.g., Flash memory, a removable hard drive, an optical disc, and so forth). The computer-readable media 606 may be configured in various other ways, as described below.

Input/output interface(s) 608 represents functionality that allows a user to enter commands and information to computing device 602 and also allows information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in various ways, as described below, to support user interaction.

Various techniques may be described in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms with various processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium configured to transmit instructions to the hardware of the computing device 602, such as via a network. Signal media typically may embody computer-readable instructions, data structures, program modules, or other data in a modulated data signal, such as carrier waves, data signals, or another transport mechanism. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware and hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module executable by the computing device 602 as software may be achieved at least partially in hardware, e.g., through computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through a distributed system, such as over a “cloud” 614 via a platform 616 as described below.

The cloud 614 includes and/or represents a platform 616 for resources 618. The platform 616 abstracts the underlying functionality of hardware (e.g., servers) and software resources of the cloud 614. The resources 618 may include applications and/or data that can be utilized while computer processing is executed on remote servers. Resources 618 can also include services provided over the Internet and/or through a subscriber network, such as a cellular or Wi-Fi network.

The platform 616 may abstract resources and functions to connect the computing device 602 with other computing devices. The platform 616 may also serve to abstract the scaling of resources to provide a corresponding level of scale to meet the demand for the resources 618 that are implemented via the platform 616. Accordingly, in an interconnected device embodiment, implementation of functionality described herein may be distributed throughout the system 600. For example, the functionality may be implemented in part on the computing device 602 as well as via the platform 616 that abstracts the functionality of the cloud 614.

In some aspects, the techniques described herein relate to a computer-implemented method comprising generating, by a first machine-learning model, test prompts for a target artificial intelligence (AI) agent based on testing guidance stored in a database, the testing guidance initially provided by a developer of the target AI agent; analyzing, by a second machine-learning model, responses from the target AI agent to the test prompts to generate an analysis report of the target AI agent in view of the testing guidance; updating, by the second machine-learning model and based on analysis of the responses, the testing guidance in the database for subsequent test prompts; and outputting, by the second machine-learning model, the analysis report.

In some aspects, the techniques described herein relate to a computer-implemented method, wherein the test prompts include adversarial inputs designed to probe security vulnerabilities of the target AI agent, the adversarial inputs including at least one of prompt injection attacks, jailbreak attacks, or unauthorized access attacks.

In some aspects, the techniques described herein relate to a computer-implemented method, wherein analyzing the responses includes assessing potential security flaws of the target AI agent; assessing a behavioral alignment of the target AI agent to defined objectives; and determining a list of potential areas to explore in the subsequent test prompts.

In some aspects, the techniques described herein relate to a computer-implemented method further comprising logging interactions between human users and the target AI agent, the interactions being analyzed by the second machine-learning model to further update the testing guidance in the database.

In some aspects, the techniques described herein relate to a computer-implemented method, wherein the second machine-learning model generates a scoring template for evaluating the responses, the scoring template including metrics for assessing at least one of understanding and clarity, response accuracy, problem resolution, or communication style of the target AI agent.

In some aspects, the techniques described herein relate to a computer-implemented method, wherein the test prompts are continuously and automatically generated by the first machine-learning model based on updated guidance in the database.

In some aspects, the techniques described herein relate to a computer-implemented method, wherein the analysis report includes suggested improvements for the target AI agent and evaluation results based on a scoring template with metrics for assessing response quality, response relevance, response completeness, and ethical considerations.

In some aspects, the techniques described herein relate to a computer-implemented method, wherein the first machine-learning model and the second machine-learning model are implemented as large language models (LLMs).

In some aspects, the techniques described herein relate to a computer-implemented method further comprising generating, by the first machine-learning model, a tree-structured conversation flow to guide generation of the test prompts, the tree-structured conversation flow including multiple branching paths designed to test an ability of the target AI agent to maintain context across a series of related queries and adapt to changing conversational directions.

In some aspects, the techniques described herein relate to a computer-implemented method further comprising fine-tuning the first machine-learning model using low-rank adaptation (LoRA) techniques based on user queries by collecting a set of user queries from interactions with the target AI agent; identifying patterns and topics in the set of user queries underrepresented in the test prompts; applying the LoRA techniques to update a subset of parameters of the first machine-learning model to maintain a general knowledge of the first machine-learning model while adapting to domain-specific query patterns; generating new test prompts using the updated first machine-learning model; and iteratively updating the testing guidance in the database based on a performance of the updated first machine-learning model.

In some aspects, the techniques described herein relate to a system comprising memory that includes a database storing testing guidance initially provided by a developer of a target artificial intelligence (AI) agent; and one or more processors communicatively coupled to the memory and configured to generate, using a first machine-learning model, test prompts for the target AI agent based on the testing guidance stored in the database; analyze, using a second machine-learning model, responses from the target AI agent to the test prompts to generate an analysis report of the target AI agent in view of the testing guidance; update the testing guidance in the database for subsequent test prompts based on analysis of the responses; and output the analysis report.

In some aspects, the techniques described herein relate to a system, wherein the first machine-learning model is configured to generate the test prompts based on a combination of goal-driven strategies and prompt aspects, the goal-driven strategies including at least one of attack, coverage, adversarial, or human-like interaction strategies, the prompt aspects including at least one of flow, question, tone, or feedback aspects.

In some aspects, the techniques described herein relate to a system, wherein the test prompts include adversarial inputs designed to probe security vulnerabilities of the target AI agent, the adversarial inputs including at least one of prompt injection attacks, jailbreak attacks, or unauthorized access attacks.

In some aspects, the techniques described herein relate to a system, wherein the analysis of the responses includes at least one of an assessment of security flaws of the target AI agent; an assessment of a behavioral alignment of the target AI agent to defined objectives; or a list of potential areas to explore in the subsequent test prompts.

In some aspects, the techniques described herein relate to a system, wherein the second machine-learning model is configured to perform a deep semantic analysis of the responses from the target AI agent and identify strengths or weaknesses in a performance of the target AI agent across multiple domains and interaction styles.

In some aspects, the techniques described herein relate to a system, wherein the one or more processors are further configured to log interactions between human users and the target AI agent; the second machine-learning model is configured to analyze the interactions to update the testing guidance in the database; and the first machine-learning model is configured to continuously and automatically generate the test prompts based on updated guidance in the database.

In some aspects, the techniques described herein relate to a system, wherein the analysis report includes suggested improvements for the target AI agent and evaluation results based on a scoring template with metrics for assessing at least one of response quality, response relevance, response completeness, and ethical considerations.

In some aspects, the techniques described herein relate to a system, wherein the first machine-learning model and the second machine-learning model are implemented as large language models (LLMs).

In some aspects, the techniques described herein relate to a system, wherein the first machine-learning model is further configured to generate a tree-structured conversation flow to guide generation of test prompts, the tree-structured conversation flow including multiple branching paths designed to test an ability of the target AI agent to maintain context across a series of related queries and adapt to changing conversational directions.

In some aspects, the techniques described herein relate to a non-transitory computer-readable storage medium storing instructions that, when executed by one or more processors, cause the one or more processors to generate, using a first machine-learning model, test prompts for a target artificial intelligence (AI) agent based on testing guidance stored in a database, the testing guidance initially provided by a developer of the target AI agent; analyze, using a second machine-learning model, responses from the target AI agent to the test prompts to generate an analysis report of the target AI agent in view of the testing guidance; update, using the second machine-learning model and based on analysis of the responses, the testing guidance in the database for subsequent test prompts; and output, using the second machine-learning model, the analysis report.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
generating, by a first machine-learning model, test prompts for a target artificial intelligence (AI) agent based on testing guidance stored in a database, the testing guidance initially provided by a developer of the target AI agent;
analyzing, by a second machine-learning model, responses from the target AI agent to the test prompts to generate an analysis report of the target AI agent in view of the testing guidance;
updating, by the second machine-learning model and based on analysis of the responses, the testing guidance in the database for subsequent test prompts; and
outputting, by the second machine-learning model, the analysis report.

2. The computer-implemented method of claim 1, wherein the test prompts include adversarial inputs designed to probe security vulnerabilities of the target AI agent, the adversarial inputs including at least one of prompt injection attacks, jailbreak attacks, or unauthorized access attacks.

3. The computer-implemented method of claim 1, wherein analyzing the responses includes:
assessing potential security flaws of the target AI agent;
assessing a behavioral alignment of the target AI agent to defined objectives; and
determining a list of potential areas to explore in the subsequent test prompts.

4. The computer-implemented method of claim 3, the method further comprising:
logging interactions between human users and the target AI agent, the interactions being analyzed by the second machine-learning model to further update the testing guidance in the database.

5. The computer-implemented method of claim 3, wherein the second machine-learning model generates a scoring template for evaluating the responses, the scoring template including metrics for assessing at least one of understanding and clarity, response accuracy, problem resolution, or communication style of the target AI agent.

6. The computer-implemented method of claim 1, wherein the test prompts are continuously and automatically generated by the first machine-learning model based on updated guidance in the database.

7. The computer-implemented method of claim 1, wherein the analysis report includes suggested improvements for the target AI agent and evaluation results based on a scoring template with metrics for assessing response quality, response relevance, response completeness, and ethical considerations.

8. The computer-implemented method of claim 1, wherein the first machine-learning model and the second machine-learning model are implemented as large language models (LLMs).

9. The computer-implemented method of claim 1, further comprising:
generating, by the first machine-learning model, a tree-structured conversation flow to guide generation of the test prompts, the tree-structured conversation flow including multiple branching paths designed to test an ability of the target AI agent to maintain context across a series of related queries and adapt to changing conversational directions.

10. The computer-implemented method of claim 1, further comprising fine-tuning the first machine-learning model using low-rank adaptation (LoRA) techniques based on user queries by:
collecting a set of user queries from interactions with the target AI agent;
identifying patterns and topics in the set of user queries underrepresented in the test prompts;
applying the LoRA techniques to update a subset of parameters of the first machine-learning model to maintain a general knowledge of the first machine-learning model while adapting to domain-specific query patterns;
generating new test prompts using the first machine-learning model with updated parameters; and
iteratively updating the testing guidance in the database based on a performance of the first machine-learning model.

11. A system comprising:
memory that includes a database storing testing guidance initially provided by a developer of a target artificial intelligence (AI) agent; and
one or more processors communicatively coupled to the memory and configured to:
generate, using a first machine-learning model, test prompts for the target AI agent based on the testing guidance stored in the database;
analyze, using a second machine-learning model, responses from the target AI agent to the test prompts to generate an analysis report of the target AI agent in view of the testing guidance;
update the testing guidance in the database for subsequent test prompts based on analysis of the responses; and
output the analysis report.

12. The system of claim 11, wherein the first machine-learning model is configured to generate the test prompts based on a combination of goal-driven strategies and prompt aspects, the goal-driven strategies including at least one of attack, coverage, adversarial, or human-like interaction strategies, the prompt aspects including at least one of flow, question, tone, or feedback aspects.

13. The system of claim 11, wherein the test prompts include adversarial inputs designed to probe security vulnerabilities of the target AI agent, the adversarial inputs including at least one of prompt injection attacks, jailbreak attacks, or unauthorized access attacks.

14. The system of claim 11, wherein the analysis of the responses includes at least one of:
an assessment of security flaws of the target AI agent;
an assessment of a behavioral alignment of the target AI agent to defined objectives; or
a list of potential areas to explore in the subsequent test prompts.

15. The system of claim 11, wherein the second machine-learning model is configured to perform a deep semantic analysis of the responses from the target AI agent and identify strengths or weaknesses in a performance of the target AI agent across multiple domains and interaction styles.

16. The system of claim 11, wherein:
the one or more processors are further configured to log interactions between human users and the target AI agent;
the second machine-learning model is configured to analyze the interactions to update the testing guidance in the database; and
the first machine-learning model is configured to continuously and automatically generate the test prompts based on updated guidance in the database.

17. The system of claim 11, wherein the analysis report includes suggested improvements for the target AI agent and evaluation results based on a scoring template with metrics for assessing at least one of response quality, response relevance, response completeness, and ethical considerations.

18. The system of claim 11, wherein the first machine-learning model and the second machine-learning model are implemented as large language models (LLMs).

19. The system of claim 11, wherein the first machine-learning model is further configured to generate a tree-structured conversation flow to guide generation of the test prompts, the tree-structured conversation flow including multiple branching paths designed to test an ability of the target AI agent to maintain context across a series of related queries and adapt to changing conversational directions.

20. A non-transitory computer-readable storage medium storing instructions that, when executed by one or more processors, cause the one or more processors to:
generate, using a first machine-learning model, test prompts for a target artificial intelligence (AI) agent based on testing guidance stored in a database, the testing guidance initially provided by a developer of the target AI agent;
analyze, using a second machine-learning model, responses from the target AI agent to the test prompts to generate an analysis report of the target AI agent in view of the testing guidance;
update, using the second machine-learning model and based on analysis of the responses, the testing guidance in the database for subsequent test prompts; and
output, using the second machine-learning model, the analysis report.
